(19) United States
(12) Patent Application Publication
(10) Pub. No.: US 2016/0012665 A1
(43) Pub. Date: Jan. 14, 2016

(54) METHOD AND SYSTEM IS DISCLOSED FOR DELIVERING ADVERTISEMENTS IN A MULTI-GAMING ENVIRONMENT

(71) Applicant: Shoutz, Inc., Austin, TX (US)

(72) Inventor: James G. Mueller, Austin, TX (US)

(73) Assignee: SHOUTZ, INC., Austin, TX (US)

(21) Appl. No.: 14/796,529

(22) Filed: Jul. 10, 2015

Related U.S. Application Data
(60) Provisional application No. 62/023,175, filed on Jul. 10, 2014.

(51) Int. Cl. G07F 17/32

(52) U.S. Cl. CPC G07F 17/3204; G07F 17/3255; G07F 17/323

(57) ABSTRACT

Method and system is disclosed for delivering advertisements and operating multiple games within a user interface. The methods include initiating display of a user interface having a primary and a secondary module, executing a first game within the primary module, wherein the first game includes a score associated with a player-user's performance, executing a second game within the secondary module, monitoring a game state of the first game, a game state of the second game, and a score of the second game, communicating information associated with the monitored score of the second game to the first game, modifying a score of the first game based upon the communicating, delivering advertisements based upon the game state of the first and second game, and modifying the user interface based upon the monitored game state of the first and second games and the delivered advertisements.

### CROSS REFERENCE TO RELATED APPLICATIONS

This application claims the benefit of U.S. Provisional Application No. 62/023,175 filed on Jul. 10, 2014 which is hereby incorporated herein by reference.

### TECHNICAL FIELD

This disclosure relates to electronic games, and more particularly to providing advertising and entertainment in a multi-module web environment.

### BACKGROUND

The statements in this section merely provide background information related to the present disclosure and may not constitute prior art.

A vast range of gambling and social games are offered on the Internet. Many online games are web-based versions of traditional gambling game such as poker and casino style games, sports betting and horse racing. Known web-based games can have virtual currency, various fiat credits, and/or real currency used as wagers. Newer web-based games utilize social media and are played for credits or “coins”.

These games and game administrators are challenged to keep player's attention and engagement on their games. For example players sometimes want to take breaks in the competition, do something different for a minute or two, or have real work interruptions. If players toggle to other challenges or amusements, the games run the risk of having the player not return to that game session, thereby losing advertising resources or a customer. Therefore, a need exists to engage users using a multi-module gaming environment having performance events from a first game applicable to a second game.

### SUMMARY

Method and system is disclosed for delivering advertisements and operating multiple games within a user interface. The methods include initiating display of a user interface, identifying a primary and a secondary module for inclusion in the user interface, each of the primary and a secondary module being a user-interface element, each of the primary and a secondary module having input and output properties, executing a first game within the primary module, wherein the first game includes a score associated with a player-user's performance, executing a second game within the secondary module, monitoring a game state of the first game, a game state of the second game, and a score of the second game, communicating information associated with the monitored score of the second game to the first game, modifying a score of the first game based upon the communicating, delivering advertisements based upon the game state of the first and second game, and modifying the user interface based upon the monitored game state of the first and second games and the delivered advertisements.

This summary is provided merely to introduce certain concepts and not to identify key or essential features of the claimed subject matter.

### BRIEF DESCRIPTION OF THE DRAWINGS

One or more embodiments will now be described, by way of example, with reference to the accompanying drawings, in which:

FIG. 1 schematically shows an exemplary gaming administration system, in accordance with the present disclosure;

FIGS. 2A, 2B, and 2C show exemplary user interfaces for displaying user-interface elements, i.e., modules, in accordance with the present disclosure;

FIG. 3 illustrates an exemplary process for operating the system, in accordance with the present disclosure; and

FIG. 4 is a block diagram of an example device 10 that can implement the features and processes, in accordance with the present disclosure.

### DETAILED DESCRIPTION

Throughout the specification and claims, the following terms take at least the meanings explicitly associated herein, unless the context dictates otherwise. The meanings identified below do not necessarily limit the terms, but merely provide illustrative examples for the terms. The meaning of “a,” “an,” and “the” includes plural reference, and the meaning of “in” includes “in” and “on.” The phrase “in one embodiment,” as used herein does not necessarily refer to the same embodiment, although it may. Similarly, the phrase “in various embodiments,” as used herein, when used multiple times, does not necessarily refer to the same embodiments, although it may. As used herein, the term “or” is an inclusive “or” operator, and is equivalent to the term “and/or,” unless the context clearly dictates otherwise. The term “based upon” is not exclusive and allows for being based on additional factors not described, unless the context clearly dictates otherwise. The word “exemplary” is used herein to mean “serving as an example, instance, or illustration.” Any embodiment described herein as “exemplary” is not necessarily to be construed as preferred or advantageous over other embodiments.

Various embodiments of the present invention will be described in detail with reference to the drawings, where like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

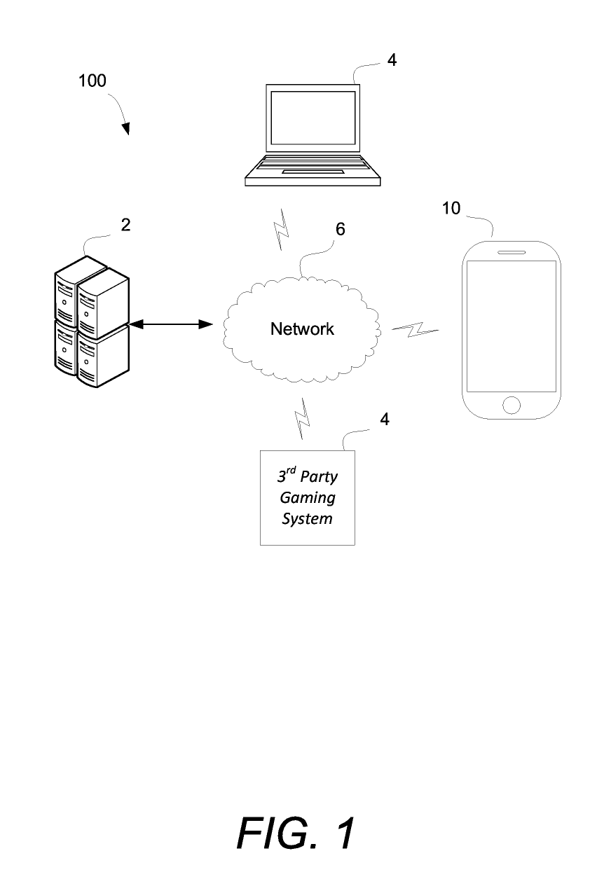

Referring now to the drawings, wherein the depictions are for the purpose of illustrating certain exemplary embodiments only and not for the purpose of limiting the same, FIG. 1 schematically shows an exemplary gaming administration system 100 that may help implement the methodologies of the present disclosure. The system 100 includes a server system 2, a communication network 6, and a mobile device 10. As shown in FIG. 1, the server system 2 may be communicatively connected to the mobile device 10 via the network 6. In one embodiment, the system includes a computing device 5. In one embodiment, the system 100 includes a 3rd party gaming system 4 that may be communicatively connected to the server 2 and/or the mobile device through the network 6. The mobile device 10 may be physically connected to the network 6 or the computing device 5 during selected periods of operation without departing from the teachings herein. Components of the system 100 are shown in FIG. 1 as single elements. Such illustration is for ease of description and it should be recognized that the system 100 may include multiple additional mobile and computing devices.

The server system 2 may be: various embodiments of a computer including high-speed microcomputers, minicomputers, mainframes, and/or data storage devices. The server system 2 preferably executes database functions including storing and maintaining a database and processes requests from the mobile device 10 to extract data from, or update, a database as described herein below. The server 7 may additionally provide processing functions for the mobile device 10 as will become apparent to those skilled in the art upon a careful reading of the teachings herein.

In addition, the mobile device 10 may include one or more applications that the user may operate. Operation may include downloading, installing, turning on, unlocking, activating, or otherwise using the application. The application may comprise at least one of an algorithm, software, computer code, and/or the like, for example, mobile application software. In the alternative, the application may be a website accessible through the world wide web.

The disclosed embodiments can be implemented in an embodiment of the system 100 that includes a back-end component, e.g., as a data server, or that includes a middleware component, e.g., an application server, or that includes a front-end component, e.g., a client computer having a graphical user interface or a Web browser through which a user can interact with an implementation of what is disclosed here, or any combination of one or more such back-end, middleware, or front-end components.

The system 100 can include various clients and servers. A client and server are generally remote from each other and typically interact through a communication network such as the network 6. The relationship of client and server arises by virtue of computer programs running on the respective computers, e.g., the device 10 and having a client-server relationship to each other.

The components of the system 100 can be interconnected by any form or medium of digital data communication, e.g., the communication network 6. Examples of communication networks include a local area network (“LAN”) and a wide area network (“WAN”), e.g., the Internet. The network 6 may facilitate the exchange of data between and among any number of the mobile devices 10, the 3rd party gaming system 4, and the server system 2.

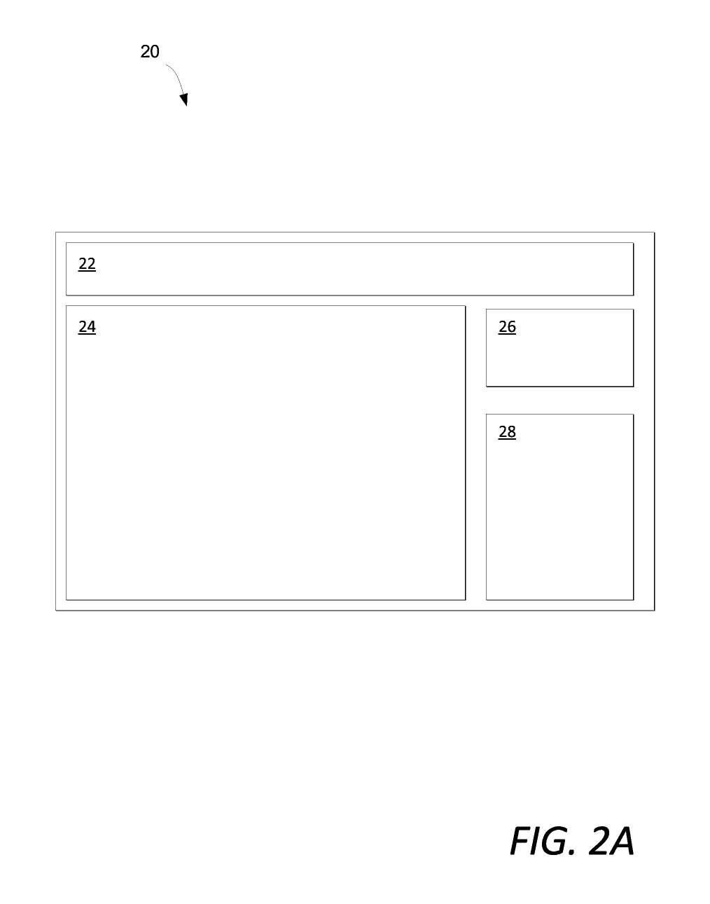

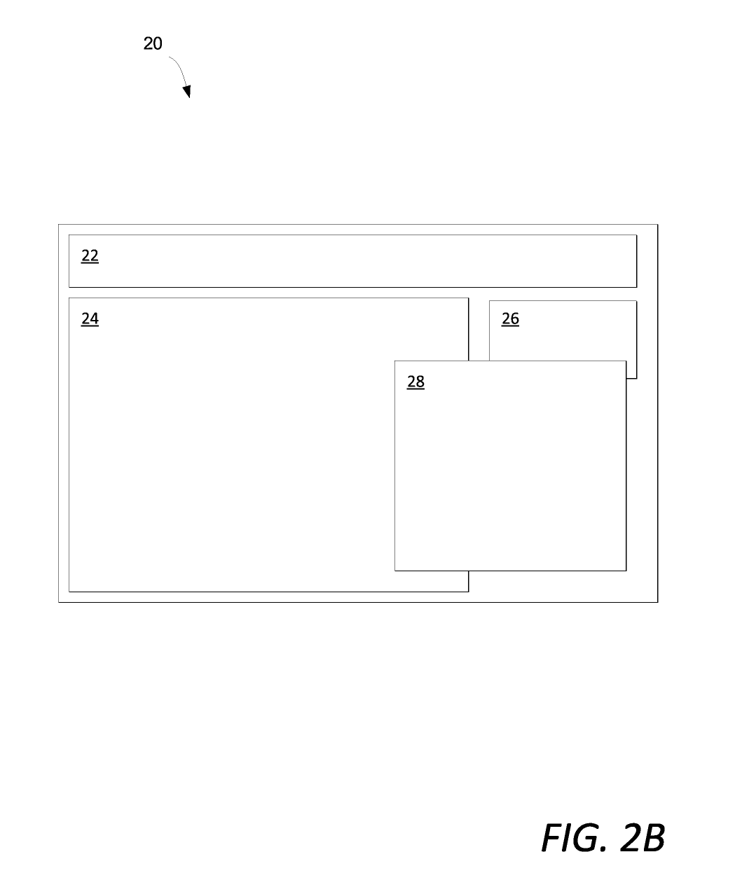

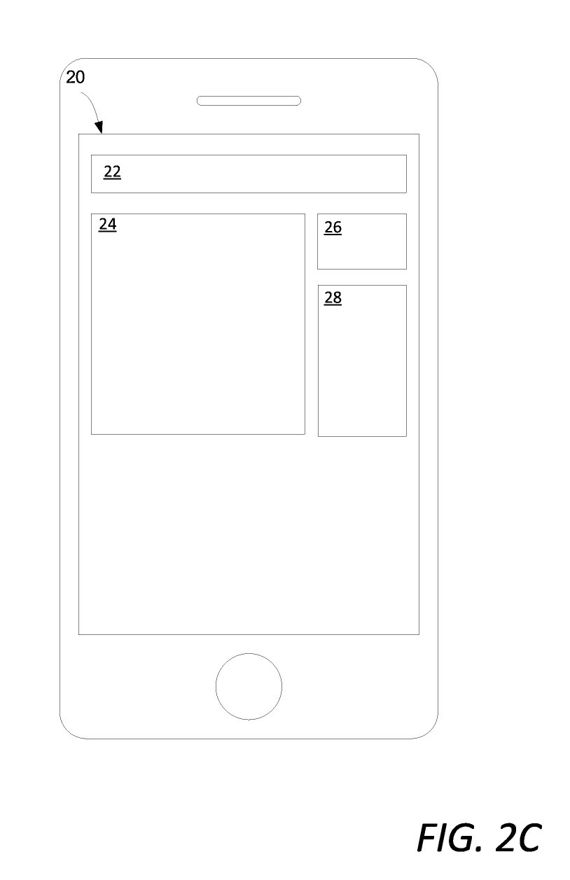

FIGS. 2A, 2B, and 2C show an exemplary user interface 20 having a plurality of modules 22, 24, 26, and 28. The interface 20 may be displayed as a webpage in some embodiments of the disclosure. The disclosure herein can be applied to various sized and arrangements of modules 22, 24, 26, and 28 on an interface 20 and is therefore not intended to be limited thereby. The interface 20 can include various functionality or informational presentations in one or more of the modules 22, 24, 26, and 28. Content for each of the modules 22, 24, 26, and 28 can be informational or functional such as a game. In one embodiment, a first module 24 is configured for game play, while a second module 22 is configured for presenting an advertisement. In one embodiment, a first module 24 is configured for game play of a first game and a second module 28 is configured for simultaneous, intermittent game play of a second game. In one embodiment, a first module 24 is configured for game play of a first game and a second module 28 is configured for game play of a second game. in one embodiment, the modules 22, 24, 26, and 28 may be dynamically sized and/or adapted for popup such as the module 28 shown in FIG. 2B. As described herein below, the module 28 may be sized and/or displayed prominently upon occurrence of a predefined event or via user actuation. FIG. 2C shows an embodiment of the interface 20 sized and adapted for display on the exemplary mobile device 10.

In various embodiments, one of the modules may be designated as a primary module. At least one module may be designated a secondary module. In one embodiment, a module may be configured to display functional and infotainment information. For example, one module may display periodic trivia-type questions as part of a game. In one embodiment, the periodic trivia type questions are presented by a secondary module. The secondary module may present unrelated challenge than the primary module, still engaging a player's competitiveness but with a change of pace that allows them to disengage from the primary module momentarily without leaving the interface 20. As described herein above, the secondary module further augments the primary module by providing points, credits, virtual currency, or any other performance metric back into the primary module and associated game.

In various embodiments, one of the modules 22, 24, 26, and 28 may be configured to automatically begin when a player opens the game page, or may be configured to require the player to click or tap on the module to execute functions associated with the module.

In one embodiment, one or more modules 22, 24, 26, and 28 may be used for advertisement and promotional purposes. For example, a module may promote an upcoming game show. Advertising could include audio visual teasers, questions, prizes, etc. In one embodiment, graphical and information may be periodically modified such as defined and projected using a countdown within a module. In this way, a game show may be participated in every predefined period such as every thirty minutes, hour, twice daily, etc. In one embodiment, when the countdown reaches 0, the designated module initiates execution of an instruction set configured to expand the module. In one embodiment, the module may incorporate a media player configured to display and participate in the game show.

A module may be configured for streaming live video in conjunction with functional interactivity for participation in a game. In one embodiment, players may participate in the game via random selection. Selected players and/or participating players may then be broadcast in a game show format. In various embodiments of the game having trivia questions, the questions may be specific to the primary game with the primary module.

In one embodiment, a player may participate in the secondary game via random selection. Participants may be offered an opportunity to be a video-linked contestant in an upcoming game show. In one embodiment, players may be offered an opportunity to play along with the show by typing in their answers. Players may receive rewards based on the outcomes of the game shows and their individual performance.

Various games may incorporate prizes for award to participating players. Awards may include points, credits, or additional plays in the primary game, virtual or physical prizes, or coupons. Further, the prize could be progressive, with the prize pool increasing if an award goes unrewarded during a particular game show. If the prize awards are credits, points or some other performance metric in a game, the points can be added to the player's game account using one or more techniques. In one embodiment, an API to the primary game administration program can be used to allow the secondary module to add the points to the player's account. The secondary module could also initiate an email or other electronic communication to the game administration system noting the player and additional points to be recorded.

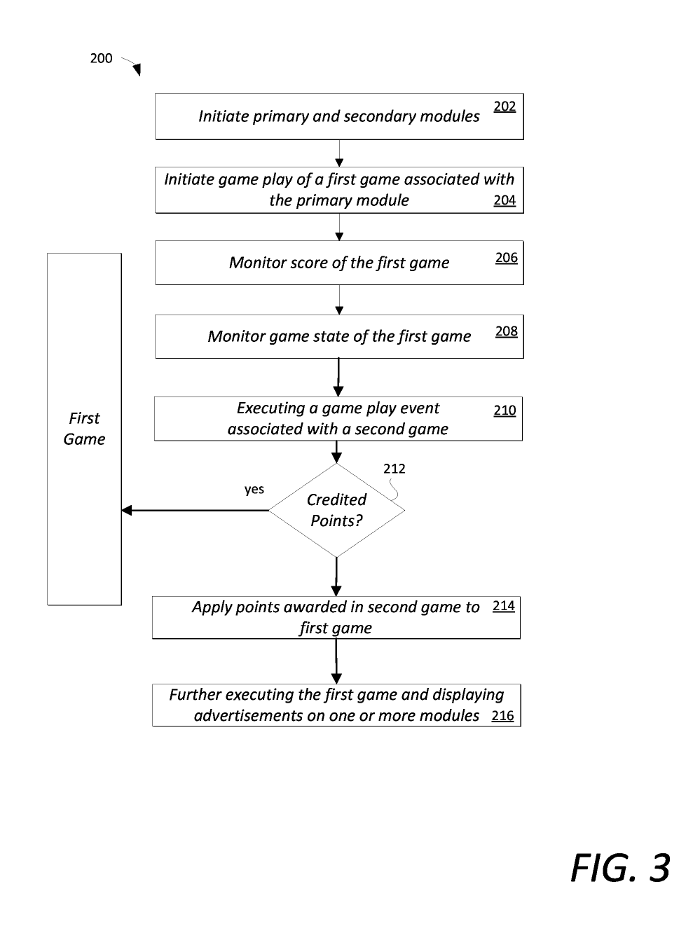

FIG. 3 illustrates an exemplary process 200 for operating an embodiment of the system 100. The process 200 is initiated at step 202 by a user upon launching a software application, e.g., a game, loading a web page, or display having an interface, e.g., the user interface 20. In the exemplary embodiment, launching the software application or loading the web page initiates a primary module having a first game and a secondary module have a second game.

During exemplary operation, a player-user executes a first game within a first module (processing block 204). They system 100 monitors a score of the game at step 206. In one embodiment, the score may be monitored by a 3rd party system. As described herein the score may be one or more performance metrics associated with game-play and the player-user's performance such as points, credits, virtual currency, etc. In one embodiment, game play may have awarded various prizes to the player-user, e.g., coupons, discounts, actual prizes, etc. In one embodiment, the performance metrics and awarded prizes are accessible via API.

At step 208, the system monitors a game state of the first game. Game state may be associated with a level of player engagement to the first game. Game states having a low level of player-user engagement may be may be a ‘paused’ state caused by player-user selection, an ending of a defined game event within the game, e.g., a game level or loss, or some other break whether initiated by the player-user or by virtue of the manner of game play of the game. As defined herein, a game break may be simply a point in the game, i.e., game state, where there is no urgency to a user's input. Defined further, there is no urgency to a user's input and no adverse actions are applied to a user's score by virtue of any delay or duration in providing a user input. In one embodiment, a game state may be inferred by position of a user's input device, e.g., cursor position, within the interface 20. When the input device's position within the interface 20 is outside of the module associated with the first game, the system 100 may be configured to infer that the player-user is disengaged from the first game after a predefined time period and that the game state is at a break.

At step 210, the system 100 may execute a game play event within a second module. Execution of the game play event within the second module may be executed upon occurrence of an event, e.g., detecting a break state of the first game, or upon direct initiation by the player-user.

At step 212, the system 100 may transfer information about points, credits or other performance metrics or awards associated with player performance during the second game to the first game. At step 214 the information transfer may result in the points, credits or other performance metrics or awards being applied to a score of the first game. In one embodiment, the information is transferred via API. In one embodiment, only a portion of the score, credits or other performance metrics are transferred to the first game. In one embodiment, transferring the score, credit, or other performance metric or award may include adding the score, credit or performance metric associated with the second game to the corresponding score, credit or performance metric associated with the first game. The player-user may go back to executing the first game with the added performance metrics or awards.

At step 216, delivers advertisements based upon the game state of the first and second game. For example, if a module is enlarged over another module such as module 28 is enlarged over module 26 in FIG. 2B, the system 100 may modify advertisements displayed on module 26. Further, engagement to the first game by the player-user or a detected game state of either the first or second game may change the type of advertisements presented. For example, video streaming ads may be presented when a disengaged or inactive game state is detected, while text or informational advertisements are displayed when the game state is active and engaged. Using the process 200, the system 100 can further entertainer the player-user and extend playing time so that a greater quantity of advertisements may be delivered. In one embodiment, at step 216, the system 100 modifies the user interface 20 based upon the game state of one or more of the first and second game and based upon a delivered advertisement within the user interface 20. Modifying the user interface includes dynamically adjusting size of one or more of the modules and/or information and functionality delivered therein.

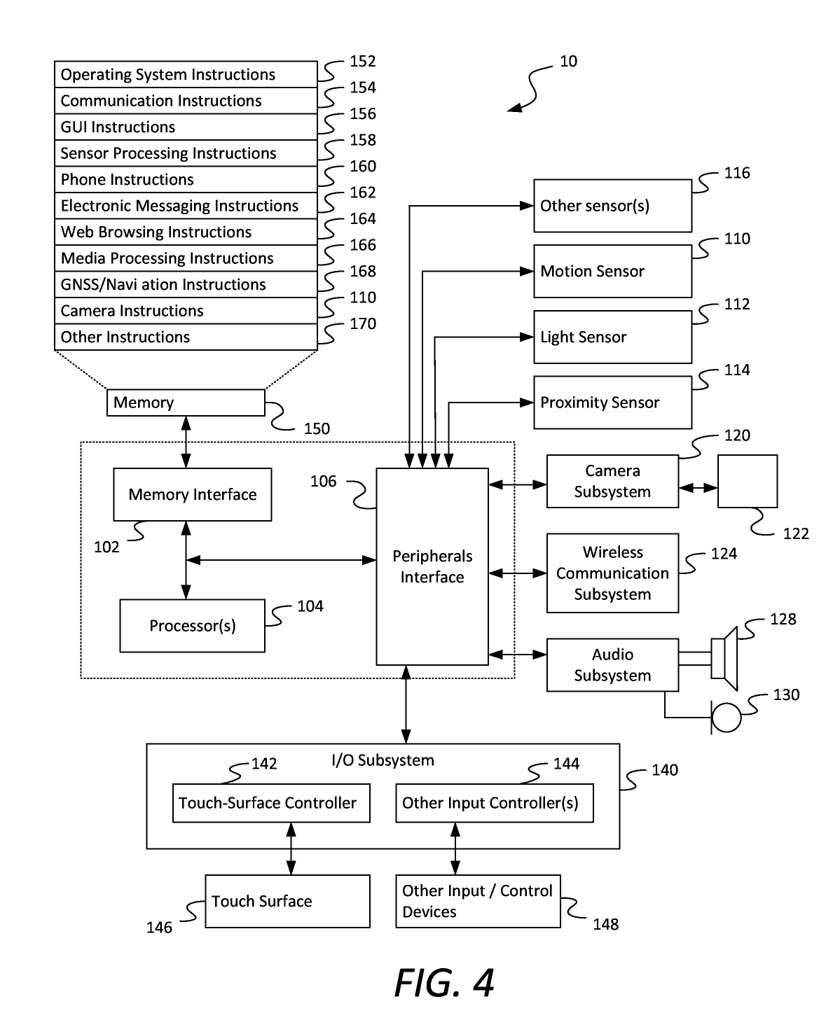

FIG. 4 is a block diagram of an example device 10 that can implement the features and processes of FIGS. 1-3. The computing device 10 can include a memory interface 102, one or more data processors, image processors and/or central processing units 104, and a peripherals interface 106. The memory interface 102, the one or more processors 104 and/or the peripherals interface 106 can be separate components or can be integrated in one or more integrated circuits. The various components in the device 10 can be coupled by one or more communication buses or signal lines.

Sensors, devices, and subsystems can be coupled to the peripherals interface 106 to facilitate multiple functionalities. For example, a motion sensor 110, a light sensor 112, and a proximity sensor 114 can be coupled to the peripherals interface 106 to facilitate orientation, lighting, and proximity functions. Other sensors 116 can also be connected to the peripherals interface 106, such as a global navigation satellite system (GNSS) (e.g., GPS receiver), a temperature sensor, a biometric sensor, magnetometer or other sensing device, to facilitate related functionalities.

A camera subsystem 120 and an optical sensor 122, e.g., a charged coupled device (CCD) or a complementary metal-oxide semiconductor (CMOS) optical sensor, can be utilized to facilitate camera functions, such as recording photographs and video clips and supplying a real-time video stream upon the display. The camera subsystem 120 and the optical sensor 122 can be used to collect images of a user to be used during authentication of a user, e.g., by performing facial recognition analysis.

Communication functions can be facilitated through one or more wireless communication subsystems 124, which can include radio frequency receivers and transmitters and/or optical (e.g., infrared) receivers and transmitters. The specific design and implementation of the communication subsystem 124 can depend on the communication network(s) over which the device 10 is intended to operate. For example, the device 10 can include communication subsystems 124 designed to operate over a GSM network, a GPRS network, an EDGE network, a Wi-Fi or WiMax network, and a Bluetooth™ network. In particular, the wireless communication subsystems 124 can include hosting protocols such that the device 14 can be configured as a base station for other wireless devices.

An audio subsystem 126 can be coupled to a speaker 128 and a microphone 130 to facilitate voice-enabled functions, such as speaker recognition, voice replication, digital recording, and telephony functions. The audio subsystem 126 can be configured to facilitate processing voice commands, voiceprinting and voice authentication, for example.

The I/O subsystem 140 can include a touch-surface controller 142 and/or other input controller(s) 144. The touch-surface controller 142 can be coupled to a touch surface 146. The touch surface 146 and touch-surface controller 142 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch surface 146.

The other input controller(s) 144 can be coupled to other input/control devices 148, such as one or more buttons, rocker switches, thumb-wheel, infrared port, USB port, and/or a pointer device such as a stylus. The one or more buttons (not shown) can include an up/down button for volume control of the speaker 128 and/or the microphone 130.

In one implementation, a pressing of the button for a first duration can disengage a lock of the touch surface 146; and a pressing of the button for a second duration that is longer than the first duration can turn power to the device 10 on or off Pressing the button for a third duration can activate a voice control, or voice command, module that enables the user to speak commands into the microphone 130 to cause the device to execute the spoken command. The user can customize a functionality of one or more of the buttons. The touch surface 146 can, for example, also be used to implement virtual or soft buttons and/or a keyboard.

The memory interface 102 can be coupled to memory 150. The memory 150 can include high-speed random access memory and/or non-volatile memory, such as one or more magnetic disk storage devices, one or more optical storage devices, and/or flash memory (e.g., NAND, NOR). The memory 150 can store an operating system 152, such as Darwin, RTXC, LINUX, UNIX, OS X, WINDOWS, or an embedded operating system such as VxWorks.

The operating system 152 can include instructions for handling basic system services and for performing hardware dependent tasks. In some implementations, the operating system 152 can be a kernel (e.g., UNIX kernel). In some implementations, the operating system 152 can include instructions for generating mobile device location and speed estimates. For example, operating system 152 can implement the indoor traffic and user service enhancement features as described with reference to FIGS. 1-3.

The memory 150 can also store communication instructions 154 to facilitate communicating with one or more additional devices, one or more computers and/or one or more servers. The memory 150 can include graphical user interface instructions 156 to facilitate graphic user interface processing; sensor processing instructions 158 to facilitate sensor-related processing and functions; phone instructions 160 to facilitate phone-related processes and functions; electronic messaging instructions 162 to facilitate electronic-messaging related processes and functions; web browsing instructions 164 to facilitate web browsing-related processes and functions; media processing instructions 166 to facilitate media processing-related processes and functions; GNSS/Navigation instructions 168 to facilitate GNSS and navigation-related processes and instructions; and/or camera instructions 110 to facilitate camera-related processes and functions.

The memory 150 can store other software instructions 170 to facilitate other processes and functions, such as the game play inputs from a player-user and other functions as described with reference to FIGS. 1-3.

The memory 150 can also store other software instructions 114, such as web video instructions to facilitate web video-related processes and functions; and/or web shopping instructions to facilitate web shopping-related processes and functions. In some implementations, the media processing instructions 166 are divided into audio processing instructions and video processing instructions to facilitate audio processing-related processes and functions and video processing-related processes and functions, respectively. An activation record and International Mobile Equipment Identity (IMEI) 114 or similar hardware identifier can also be stored in memory 150.

Each of the above identified instructions and applications can correspond to a set of instructions for performing one or more functions described above. These instructions need not be implemented as separate software programs, procedures, or modules. The memory 150 can include additional instructions or fewer instructions. Furthermore, various functions of the device 10 can be implemented in hardware and/or in software, including in one or more signal processing and/or application specific integrated circuits.

While this specification contains many specifics, these should not be construed as limitations on the scope of what being claims or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understand as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Various modifications may be made to the disclosed implementations and still be within the scope of the following claims. Therefore, it is intended that the disclosure not be limited to the particular embodiment(s) disclosed for carrying out this disclosure, but that the disclosure will include all embodiments falling within the scope of the appended claims.

1. A method comprising:
initiating display of a user interface having a primary and a secondary module, each of the primary and a secondary module being a user-interface element, each of the primary and a secondary module having input and output properties;
executing a first game within the primary module, wherein the first game includes a score associated with a player-user's performance;
executing a second game within the secondary module;
monitoring a game state of the first game, and a score of the second game;
communicating information associated with the monitored score of the second game to the first game;
modifying a score of the first game based upon the communicating;
delivering advertisements based upon the game state of the first and second game; and
modifying the user interface based upon the monitored game state of the first game and the delivered advertisements.

2. The method of claim 1, further comprising:
monitoring a game state of the second game; and
further modifying the user interface based upon the monitored game state of the second game.

3. The method of claim 1, wherein communicating information associated with the monitored score of the second game to the first game includes extracting information from an application programming interface (API) for one or more of the primary and secondary modules.

4. The method of claim 1, wherein the score is represented as one or more of points, credits, or virtual currency.

5. The method of claim 1, further comprising:
executing game events associated with the second game in response to a monitored game state of the first game.

6. The method of claim 5, wherein game events of the second game are executed when a game state associated with player-user inactivity or disengagement of the first game is detected.

7. The method of claim 6, wherein the game state associated with player-user inactivity or disengagement of the first game is inferred when a cursor input position is outside of the primary module for a predefined time period.

8. The method of claim 5, wherein the executing of the game events associated with the second game are executed in response to a monitored game state of the first game corresponding to a loss.

9. A non-transitory computer-readable medium including one or more sequences of instructions which, when executed by one or more processors, causes operations comprising:
initiating display of a user interface having a primary and a secondary module, each of the primary and a secondary module being a user-interface element, each of the primary and a secondary module having input and output properties;
identifying an advertisement module for delivery of an ad within the user interface;
executing a first game within the primary module, wherein the first game includes a score associated with a player-user's performance;
executing a second game within the secondary module;
monitoring a game state of the first game, a game state of the second game, and a score of the second game;
communicating information associated with the monitored score of the second game to the first game;
modifying a score of the first game based upon the communicating;
delivering advertisements on the advertisement module based upon the game state of the first and second game; and
modifying the user interface based upon the monitored game state of the first and second games and the delivered advertisements.

10. The non-transitory computer-readable medium of claim 9, wherein initiating display of a user interface comprises loading a web page.

11. The non-transitory computer-readable medium of claim 9, wherein communicating information associated with the monitored score of the second game to the first game includes extracting information from an application programming interface (API) for one or more of the primary and secondary modules.

12. The non-transitory computer-readable medium of claim 9, wherein the score is represented as one or more of points, credits, or virtual currency.

13. The non-transitory computer-readable medium of claim 9, further comprising:
executing game events associated with the second game in response to a monitored game state of the first game.

14. The non-transitory computer-readable medium of claim 13, wherein game events of the second game are executed when a game state associated with player-user inactivity or disengagement of the first game is detected.

15. The non-transitory computer-readable medium of claim 14, wherein the game state associated with player-user inactivity or disengagement of the first game is inferred when a cursor input position is outside of the primary module for a predefined time period.

16. The non-transitory computer-readable medium of claim 9, wherein the second game includes video streaming, trivia questions, and social networking communication capabilities.

17. A system comprising:
one or more processors; and
a non-transitory computer-readable medium including one or more sequences of instructions which, when executed by one or more processors, causes operations comprising:
initiating display of a user interface by loading a webpage, the user interface having a primary and a secondary module, each of the primary and a secondary module being a user-interface element, each of the primary and a secondary module having input and output properties;
executing a first game within the primary module, wherein the first game includes a score associated with a player-user's performance;
executing a second game within the secondary module;
monitoring a game state of the first game, a game state of the second game, and a score of the second game;
communicating information associated with the monitored score of the second game to the first game;
modifying a score of the first game based upon the communicating;
delivering advertisements based upon the game state of the first and second game; and
modifying the user interface based upon the monitored game state of the first and second games and the delivered advertisements.

18. The system of claim 17, wherein communicating information associated with the monitored score of the second game to the first game includes extracting information from an application programming interface (API) for one or more of the primary and secondary modules.

19. The system of claim 17, the operations further comprising:
executing game events associated with the second game in response to a monitored game state of the first game, wherein game events of the second game are executed when a game state associated with player-user inactivity or disengagement of the first game is detected, wherein the game state associated with player-user inactivity or disengagement of the first game is inferred when a cursor input position is outside of the primary module for a predefined time period.

20. The system of claim 17, wherein the second game includes audio/video streaming, trivia questions, and social networking communication capabilities.
